(19) United States
(12) Patent Application Publication
(10) Pub. No.: US 2004/0003344 A1
(43) Pub. Date: Jan. 1, 2004

(54) Method for utilizing electronic book readers to access multiple-ending electronic books

(75) Inventors: Cheng-Shing Lai, Taipei Hsieng (TW); Xiao-Wen Liu, Nanking (CN)

Correspondence Address: BACON & THOMAS, PLLC, 625 SLATERS LANE, FOURTH FLOOR, ALEXANDRIA, VA, 22314

(73) Assignee: Inventec Appliances Corp., Taipei Hsieng (TW)

(21) Appl. No.: 10/180,531

(22) Filed: Jun. 27, 2002

(51) Int. Cl. G06F 15/00

(52) U.S. Cl. 715/501.1

(57) ABSTRACT

The invention is to provide a method for utilizing electronic book readers to access multiple-ending electronic books, the said method consisting of disposing a plurality of endings and a minimum of one selectable page in the said electronic books, with each said selectable page having a quantity of hyperlinks, the said hyperlinks providing links respectively assigned to pages in the said electronic book such that when an electronic book is accessing a said electronic book, different hyperlinks being selected on the said selectable page are read to display the content of the said electronic book through the said hyperlinks corresponding to the assigned pages.

### BACKGROUND OF THE INVENTION

1) Field of the Invention

The invention herein relates to a method for utilizing electronic book readers to access multiple-ending electronic books.

2) Description of the Prior Art

Electronic books utilize electronic book editing software and electronic book publishing software to convert the planar written content of conventional paper books into an electronic file form that can be stored in personal computers, personal digital assistants, palmtop computers, cellular telephones, or other devices with electronic book reading capability (hereafter referred to as electronic book readers). A minimum of one electronic book reading software and electronic book application software are installed in a said electronic book reader, enabling the said electronic book reader to utilize the said electronic book reading software and application software for opening and reading the said electronic book electronic files and even adjusting the layout, chapters and sections, paragraph, and page position of the reading material as well as provide for the addition of personal annotation as desired during the electronic book reading process to facilitate and ease reading the content of the said electronic book and, furthermore, graphics and audio as well as vocabulary explanations can also be inputted.

Taking conventional paper user's manuals and electronic book user's manuals as examples, searching for instructions about a certain operation in a conventional user's manual requires first reading the content of the chapters and sections for information relevant to the said certain operation and then skimming the text of the said relevant chapters and sections for explanations about the said certain operation. Or, it may be necessary to browse the conventional user's manual one page at a time to learn more about the said certain operation. As such, searching the content index of a conventional paper user's manual content is quite inconvenient, while searching for needed information in electronic books through the faster approach of inputting key words saves considerable time and is much more expedient.

However, after conventional paper books are published as electronic books, the said electronic book and paper book are completely identical in content and, furthermore, both have but a single ending, enabling the reading user to only read the book page by page according to the preset pagination and without the option of different content arrangement. Although this complies with ordinary book reading practices, the limitations of conventional books remain unsolved, confining the development of the said electronic books because the traditional reading approach has not been significantly changed. Therefore, if the option of selectable thematic or plot refinement while a said electronic book is read can be further developed and thereby enable the said electronic book to have a reading approach different from that of conventional books, they would be happily accepted by the general public.

### SUMMARY OF THE INVENTION

In view of the drawbacks of both conventional electronic books and conventional paper books such as provision for only a single identical ending that limits electronic book development to the conventional reading model, the inventor of the invention herein conducted extensive research and experimentation that culminated in the successful development and design of a method for utilizing electronic book readers to access multiple-ending electronic books, the said method consisting of disposing a plurality of endings and a minimum of one selectable page in the said electronic books, with each said selectable page having a quantity of hyperlinks, the said hyperlinks providing links respectively assigned to pages in the said electronic book such that when an electronic book is accessing a said electronic book, different hyperlinks being selected on the said selectable page are read to display the content of the said electronic book through the said hyperlinks corresponding to the assigned pages.

### BRIEF DESCRIPTION OF THE DRAWINGS

FIG. 1 is a flowchart of the method for utilizing electronic book readers to access multiple-ending electronic books of the invention herein.

FIG. 2 is a flowchart of individual page content processing by the central processor unit in the electronic book reader of the invention herein.

FIG. 3 is a flowchart of the said central processing unit page content display and post-processing routine after individual page content processing by the central processing unit in the electronic book reader.

### DETAILED DESCRIPTION OF THE INVENTION

In the method for utilizing electronic book readers to access multiple-ending electronic books of the invention herein, the basic structure of the said multiple-ending electronic book reader is identical to that of a conventional electronic book reader in which page turning, page layout, chapters and sections, paragraphs, and page position along with personal annotation are selectively accomplished through keys or a screen installed thereon, while the said method consists of disposing a plurality of endings and a minimum of one selectable page in the said multiple-ending electronic books, with each said selectable page having a quantity of hyperlinks. The said hyperlinks provide links respectively assigned to pages in the said electronic book such that when an electronic book reader (such as a personal computer, a personal digital assistant, or a cellular telephone, etc.) utilizing internally installed electronic book reading software is accessing a said electronic book, the central processing unit in the said electronic book reader senses the different hyperlink being selected on the said selectable page and based on the said hyperlinks displays the assigned page of a hyperlink, enabling the reading of one of the endings; as such, each time a said electronic book is read, the reading user can select different hyperlinks based on personal preference to control the thematic or plot development of the said electronic book and thereby read different endings.

In the invention herein, the said hyperlinks are organized into a plurality of hyperlink groups and the said hyperlink groups respectively correspond to one of the endings; the content of each said ending is different such that when the said electronic book reader is in the process of electronic book reading, the central processing unit accesses the different endings that were selected and displays the assigned page of a hyperlink, enabling the display of different content from the said electronic book and, furthermore, based on different hyperlinks in dissimilar hyperlink groups such that the said electronic book displays different endings.

In the invention herein, each said selectable page of the said electronic book has a matching approval label, the said approval label respectively corresponding to an approval page such that when the said electronic book reader central processing unit reads a selected page, the said electronic book reader displays a quantity of selectable hyperlinks on its screen and if the said central processing unit has not read any hyperlink selection after a certain wait period, the said central processing unit directly reads the matching approval label of the said selectable page and based on the said approval label displays the approval page corresponding to the said approval label.

In the invention herein, the said electronic book has an internally disposed classifier label, the said classifier label utilized to indicate whether a said electronic book is a multiple-ending electronic book such that when the said central processing unit reads the said electronic book, it first reads the said classifier label to determine whether it is a multiple-ending electronic book; if yes, the said electronic reader electronic book reading software executes a corresponding state change (such as operating interface state change) to enable operational processing based on the multiple-ending electronic book model; otherwise, processing is executed based on the conventional electronic book model.

In the invention herein, the said electronic book has an internally disposed version label, the said version label utilized to indicate the version number of the said electronic book, enabling the said central processing unit to read the said version number to determine whether the said electronic book reading software is capable of processing a said electronic book through its version number and if yes, the said electronic book reading software continues accessing the said electronic book; otherwise, an error message is displayed to enable the user to continue operation according to the said error message.

In the invention herein, the said electronic book includes a conclusion label, the said conclusion label utilized to indicate endings of the said electronic book; the said electronic book reader is capable of accessing the conclusion label within a single page and if a said conclusion label is sensed, continuous reading is halted at the next consecutive page, with the said page functioning as the ending.

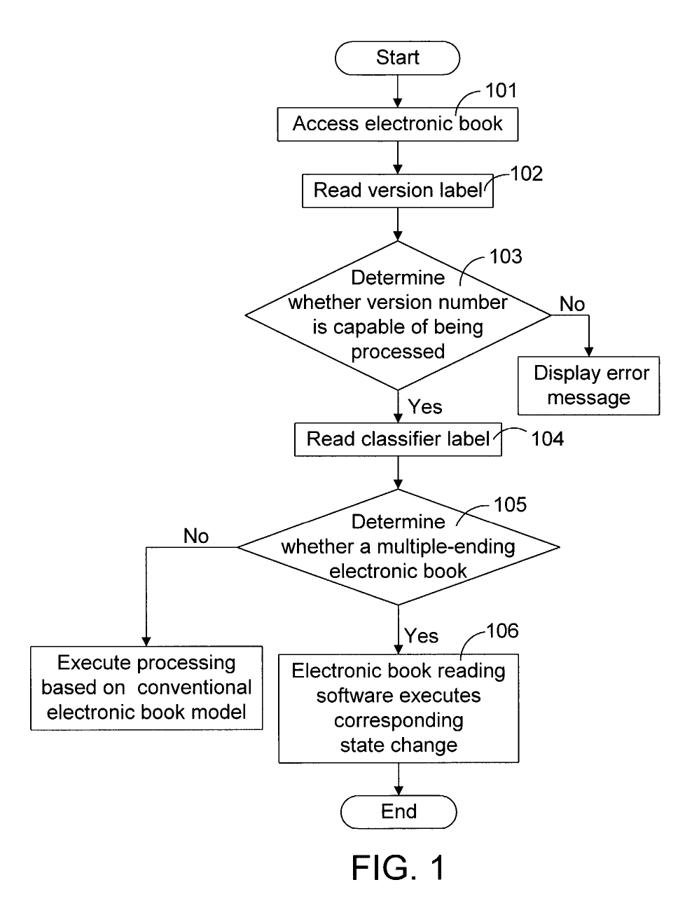

In the embodiment of the invention herein, the said electronic book reader utilizes the said electronic book software, enabling its central processing unit to start accessing the said electronic book according to the procedures below (referring to FIG. 1):

101: Access the said electronic book selected in the said electronic book reader.

102: Read the version label of the said electronic book.

103: Determine the version number of the said version label and whether the said electronic book reading software is capable of processing the version number; if yes, execute step 104; otherwise, display an error message.

104: Read the classifier label of the said electronic book.

105: Determine whether a multiple-ending electronic book; if a multiple-ending electronic book, then execute step 106; otherwise, execute processing based on the conventional electronic book processing model.

106: The said electronic book reading software executes the corresponding state change to enable operational processing based on the multiple-ending electronic book model.

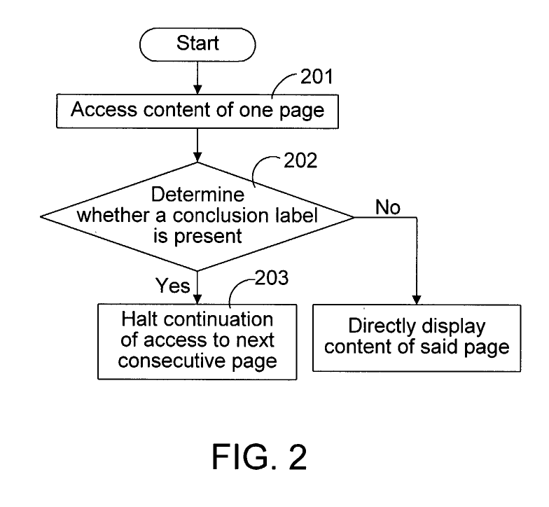

In the said embodiment, the said electronic book reader utilizes the said electronic book reading software, enabling its central processing unit to start accessing each page of the said multiple-ending electronic book according to the procedures below (referring to FIG. 2):

201: Access the content of one page in the said electronic book.

202: Determine whether there is a conclusion label; if present, then execute step 203; otherwise, directly execute processing for the display of the said page.

203: Display content of the said page and halt continuation of access to the next consecutive page, the said page functioning as the ending.

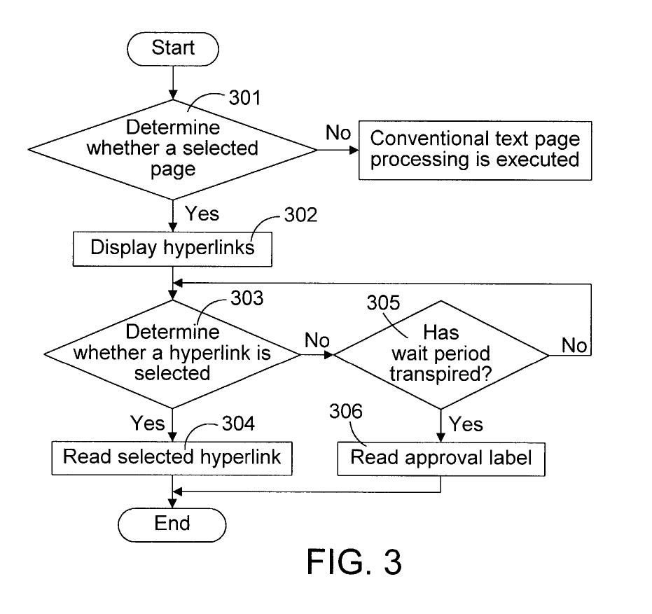

In the said embodiment, after the content of one page in the said electronic book is accessed, the said central processing unit displays the said page and executes post-read processing according to the procedures below (referring to FIG. 3):

301: Determine whether said page is the selected page; if yes, then the next step is executed; otherwise, conventional text page processing is executed.

302: Display corresponding hyperlinks on the said screen.

303: Determine whether a hyperlink is selected; if yes, execute step 304; otherwise, execute step 305.

304: Read the selected hyperlink and based on the said hyperlink display the assigned page of the said hyperlink.

305: Determine whether a wait period has transpired; if yes, execute the next step; otherwise, execute step 303.

306: Directly read the matching approval label of the said selected page and based on the said approval label display the approval page corresponding to the said approval label.

In the invention herein, since the said multiple-ending electronic book text page processing procedures are identical to that of conventional electronic book text page processing, they shall not be further elaborated.

In the invention herein, the content of the said electronic book can be edited utilizing XLM programming syntax, with the content including the embedding of the said hyperlinks, text page assignments, approval labels, approval pages, alphanumeric character and graphics to enable the reading of electronic books on different platforms.

1. A method for utilizing electronic book readers to access multiple-ending electronic books, the said method consisting of disposing a plurality of endings and a minimum of one selectable page in the said electronic books, with each said selectable page having a quantity of hyperlinks; the said hyperlinks provide links respectively assigned to pages in the said electronic book such that when an electronic book reader utilizing internally installed electronic book reading software is accessing a said electronic book, its central processing unit executes the following procedures;
reading each text page of the said electronic book sequentially;
then reading different said hyperlinks being being selected on a said selectable page;
displaying the assigned page of the said hyperlink based on the said hyperlink.

2. A method for utilizing electronic book readers to access multiple-ending electronic books as claimed in claim 1 in which of the said hyperlinks are organized into a plurality of hyperlink groups and the said hyperlink groups respectively correspond to one of the said endings; the content of each said ending is different such that when the said electronic book reader is in the process of electronic book reading, its central processing unit accesses the different said endings that were selected and displays the assigned page of a said hyperlink, enabling the display of different content from the said electronic book and, furthermore, based on different said hyperlinks in dissimilar said hyperlink groups such that the said electronic book displays different said endings.

3. A method for utilizing electronic book readers to access multiple-ending electronic books as claimed in claim 1 in which each said selectable page of the said electronic book has a matching approval label, the said approval label respectively corresponding to an approval page such that when the said electronic book reader central processing unit accesses a selected page, the said electronic book reader displays a quantity of selectable said hyperlinks on its screen and if the said central processing unit has not read any said hyperlink selection after a certain wait period, the said central processing unit directly reads the said matching approval label of the said selected page and based on the said approval label displays the approval page corresponding to the said approval label.

4. A method for utilizing electronic book readers to access multiple-ending electronic books as claimed in claim 3 in which the said electronic book has an internally disposed classifier label, the said classifier label utilized to indicate whether a said electronic book is a multiple-ending electronic book such that when the said central processing unit accesses the said electronic book, it first reads the said classifier label to determine whether it is a said multiple-ending electronic book; if yes, the said electronic reader electronic book reading software executes a corresponding state change to enable operational processing based on the multiple-ending electronic book model; otherwise, processing is executed based on the conventional electronic book model.

5. A method for utilizing electronic book readers to access multiple-ending electronic books as claimed in claim 4 in which the said electronic book has an internally disposed version label, the said version label utilized to indicate the version number of the said electronic book, enabling the said central processing unit to read the said version number to determine whether the said electronic book reading software is capable of processing a said electronic book through its version number and if yes, the said electronic book reading software continues accessing the said electronic book; otherwise, an error message is displayed to enable the user to continue operation according to the said error message.

6. A method for utilizing electronic book readers to access multiple-ending electronic books as claimed in claim 5 in which the said conclusion label utilized to indicate endings of the said electronic book; the said electronic book reader is capable reading the said conclusion label within a single page and if the said conclusion label is sensed, continuous reading is halted at the next consecutive page, with the said page functioning as the ending.

7. A method for utilizing electronic book readers to access multiple-ending electronic books as claimed in claim 6 in which the said electronic book reader utilizes the said electronic book reading software, enabling its said central processing unit to start reading the said electronic book according to the procedures below:
accessing the said electronic book being selected in the said electronic book reader;
then reading the said version label of the said electronic book;
next, determining whether the said version number of the said version label is the version number able to be processed by said electronic book reading software; if yes, the process continues to read the said classifier label of the said electronic book;
determining whether the said electronic book is a said multiple-ending electronic book; if it is a said multiple-ending electronic book, enabling the said electronic reader electronic book reading software to execute a corresponding state change to enable operational processing based on the multiple-ending electronic book model.

8. A method for utilizing electronic book readers to access multiple-ending electronic books as claimed in claim 7 in which the said electronic book reader utilizes the said electronic book reading software and starts accessing each page of the said multiple-ending electronic book according to the procedures below:
accessing the content of one page in the said electronic book;
determining whether there is a said conclusion label; if present, then displaying the content of the said page and halting continuation of access to the next consecutive page, with the said page functioning as the ending.

9. A method for utilizing electronic book readers to access multiple-ending electronic books as claimed in claim 7 in which after the content of one page is accessed in the said electronic book reader, the following procedures are executed:
determining whether said page is the selected page; if yes, then displaying the corresponding said hyperlinks on the said screen;
determining whether any said hyperlinks have been selected; if yes, then reading the selected said hyperlink and, displaying the said assigned page of the said hyperlink based on the said hyperlink.
